(19) United States
(12) Patent Application Publication
(10) Pub. No.: US 2026/0074124 A1
(43) Pub. Date: Mar. 12, 2026

(54) WOUND CAPACITOR PACKAGING STRUCTURE AND SEALING ELEMENT THEREOF

(71) Applicant: APAQ TECHNOLOGY CO., LTD., Miaoli County (TW)

(72) Inventors: CHIEH LIN, HSINCHU COUNTY (TW); CHENG-JHE SIE, Miaoli County (TW); CHUNG-JUI SU, KAOHSIUNG CITY (TW)

(21) Appl. No.: 19/014,472

(22) Filed: Jan. 9, 2025

(30) Foreign Application Priority Data
Sep. 11, 2024 (TW) 113134367

(51) Int. Cl. H01G 9/10; H01G 9/145; H01G 9/15

(52) U.S. Cl. CPC H01G 9/10; H01G 9/145; H01G 9/151

(57) ABSTRACT

A wound capacitor packaging structure and a sealing element thereof. The wound capacitor packaging structure includes a wound assembly, a conductive assembly, a package casing and a sealing element. The sealing element is disposed inside the package casing for cooperating with the package casing. The package casing has a surrounding concave position-limiting portion recessed inward to press the sealing element, and a surrounding convex end portion protruding from the surrounding concave position-limiting portion. The sealing element includes an elastomeric seal structure pressed by the surrounding concave position-limiting portion, and an oleophobic and high-temperature-resistant structure for protecting the elastomeric seal structure. The oleophobic and high-temperature-resistant structure can be configured to enable the wound capacitor packaging structure to retain more than 93% of the predetermined initial capacitance when the wound capacitor packaging structure is powered off at a maximum temperature of 150° C. for less than 4,000 hours.

### CROSS-REFERENCE TO RELATED PATENT APPLICATION

This application claims the benefit of priority to Taiwan Patent Application No. 113134367, filed on Sep. 11, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor packaging structure and a sealing element thereof, and more particularly to a wound capacitor packaging structure and a sealing element thereof.

### BACKGROUND OF THE DISCLOSURE

Various applications of capacitors include being used in home appliances, computer motherboards and peripherals, power supplies, communication products and automobiles. Capacitors such as solid electrolytic capacitors are mainly used to provide functions such as filtering, bypassing, rectifying, coupling, blocking and transforming. However, there is still room for improvement in the related art of the capacitor.

### SUMMARY OF THE DISCLOSURE

In response to the above-referenced technical inadequacy, the present disclosure provides a wound capacitor packaging structure and a sealing element for reducing causticity of an elastomeric seal structure by an oil-containing cooling liquid, and retaining a predetermined percentage of a predetermined initial capacitance of the wound capacitor packaging structure.

In order to solve the above-mentioned problems, one of the technical aspects adopted by the present disclosure is to provide a wound capacitor packaging structure, which includes a wound assembly, a conductive assembly, a package casing and a sealing element. The wound assembly includes a wound positive conductive foil, a wound negative conductive foil and two wound insulating separators. The conductive assembly includes a first conductive pin electrically contacting the wound positive conductive foil and a second conductive pin electrically contacting the wound negative conductive foil. The package casing is configured to receive the wound assembly. The sealing element is disposed inside the package casing and cooperating with the package casing, and the sealing element is configured to prevent the wound assembly from contacting an external environment. One of the two wound insulating separators is disposed between the wound positive conductive foil and the wound negative conductive foil, and one of the wound positive conductive foil and the wound negative conductive foil is disposed between the two wound insulating separators. The first conductive pin includes a first embedded portion accommodated inside the package casing and enclosed by the sealing element, and a first exposed portion exposed outside the package casing, and the second conductive pin includes a second embedded portion accommodated inside the package casing and enclosed by the sealing element, and a second exposed portion exposed outside the package casing. The package casing has a surrounding concave position-limiting portion recessed inward to press the sealing element, and a surrounding convex end portion protruding from the surrounding concave position-limiting portion to abut against the sealing element. The sealing element includes an elastomeric seal structure pressed by the surrounding concave position-limiting portion, and an oleophobic and high-temperature-resistant structure for protecting the elastomeric seal structure. The wound capacitor packaging structure is configured to provide a predetermined initial capacitance, the oleophobic and high-temperature-resistant structure of the sealing element is configured to enable the wound capacitor packaging structure to retain more than 93% of the predetermined initial capacitance when the wound capacitor packaging structure is powered off at a maximum temperature of 150° C. for less than 4,000 hours, and the oleophobic and high-temperature-resistant structure of the sealing element is configured to enable the wound capacitor packaging structure to retain more than 85% of the predetermined initial capacitance when the wound capacitor packaging structure is powered on at a maximum temperature of 150° C. for less than 4,000 hours.

In order to solve the above-mentioned problems, another one of the technical aspects adopted by the present disclosure is to provide a wound capacitor packaging structure, which includes a wound assembly, a conductive assembly, a package casing and a sealing element. The conductive assembly includes a first conductive pin and a second conductive pin. The package casing is configured to receive the wound assembly. The sealing element is disposed inside the package casing and cooperating with the package casing, and the sealing element is configured to prevent the wound assembly from contacting an external environment. The package casing has a surrounding concave position-limiting portion recessed inward to press the sealing element, and a surrounding convex end portion protruding from the surrounding concave position-limiting portion to abut against the sealing element. The sealing element includes an elastomeric seal structure pressed by the surrounding concave position-limiting portion, and an oleophobic and high-temperature-resistant structure for protecting the elastomeric seal structure. The wound capacitor packaging structure is configured to provide a predetermined initial capacitance, the oleophobic and high-temperature-resistant structure of the sealing element is configured to enable the wound capacitor packaging structure to retain more than 93% of the predetermined initial capacitance when the wound capacitor packaging structure is powered off at a maximum temperature of 150° C. for less than 4,000 hours, and the oleophobic and high-temperature-resistant structure of the sealing element is configured to enable the wound capacitor packaging structure to retain more than 85% of the predetermined initial capacitance when the wound capacitor packaging structure is powered on at a maximum temperature of 150° C. for less than 4,000 hours.

In order to solve the above-mentioned problems, yet another one of the technical aspects adopted by the present disclosure is to provide a sealing element applied to a wound capacitor packaging structure including a wound assembly, a conductive assembly and a package casing. The sealing element is disposed inside the package casing and cooperating with the package casing, and the sealing element is configured to prevent the wound assembly from contacting an external environment. The package casing has a surrounding concave position-limiting portion recessed inward to press the sealing element, and a surrounding convex end portion protruding from the surrounding concave position-limiting portion to abut against the sealing element. The sealing element includes an elastomeric seal structure pressed by the surrounding concave position-limiting portion, and an oleophobic and high-temperature-resistant structure for protecting the elastomeric seal structure. The wound capacitor packaging structure is configured to provide a predetermined initial capacitance, the oleophobic and high-temperature-resistant structure of the sealing element is configured to enable the wound capacitor packaging structure to retain more than 93% of the predetermined initial capacitance when the wound capacitor packaging structure is powered off at a maximum temperature of 150° C. for less than 4,000 hours, and the oleophobic and high-temperature-resistant structure of the sealing element is configured to enable the wound capacitor packaging structure to retain more than 85% of the predetermined initial capacitance when the wound capacitor packaging structure is powered on at a maximum temperature of 150° C. for less than 4,000 hours.

In one of the possible or preferred embodiments, the package casing has an opening, and the sealing element is configured to be disposed at the opening of the package casing so as to close the opening of the package casing.

In one of the possible or preferred embodiments, the elastomeric seal structure has an upper surface facing away from the wound assembly, a lower surface facing the wound assembly, an outer surrounding surface connected between the upper surface and the lower surface, and at least two through holes connected between the upper surface and the lower surface, and the oleophobic and high-temperature-resistant structure includes an oleophobic and high-temperature-resistant structural layer containing a predetermined oil-resistant material.

In one of the possible or preferred embodiments, when the upper surface, the lower surface and the outer surrounding surface of the elastomeric seal structure are covered by the oleophobic and high-temperature-resistant structural layer, the elastomeric seal structure is completely covered by the oleophobic and high-temperature-resistant structural layer, thereby preventing the upper surface, the lower surface and the outer surrounding surface of the elastomeric seal structure from contacting the oil-containing cooling liquid.

In one of the possible or preferred embodiments, when the upper surface and the outer surrounding surface of the elastomeric seal structure are covered by the oleophobic and high-temperature-resistant structural layer, the elastomeric seal structure is partially covered by the oleophobic and high-temperature-resistant structural layer, thereby preventing both the upper surface and the outer surrounding surface of the elastomeric seal structure from contacting the oil-containing cooling liquid.

In one of the possible or preferred embodiments, when the upper surface of the elastomeric seal structure is covered by the oleophobic and high-temperature-resistant structural layer, the elastomeric seal structure is partially covered by the oleophobic and high-temperature-resistant structural layer, thereby preventing the upper surface of the elastomeric seal structure from contacting the oil-containing cooling liquid.

In one of the possible or preferred embodiments, when an inner surface of each of the plurality of through holes of the elastomeric seal structure is covered by the oleophobic and high-temperature-resistant structural layer, the elastomeric seal structure is partially covered by the oleophobic and high-temperature-resistant structural layer, thereby preventing the inner surface of each of the plurality of through holes of the elastomeric seal structure from contacting the oil-containing cooling liquid.

In one of the possible or preferred embodiments, before the sealing element is pressed by the surrounding concave position-limiting portion, the elastomeric seal structure of the sealing element has an outer surrounding concave portion, the outer surrounding concave portion of the elastomeric seal structure has an outer surrounding concave space configured to accommodate a part of the surrounding concave position-limiting portion, and a concave contour of the outer surrounding concave portion of the elastomeric seal structure and a concave contour of the surrounding concave position-limiting portion of the package casing correspond to each other.

In one of the possible or preferred embodiments, after the sealing element is pressed by the surrounding concave position-limiting portion, a large part of the outer surrounding concave portion of the elastomeric seal structure is uniformly pressed by the surrounding concave position-limiting portion, so that an outer peripheral area of the outer surrounding concave portion of the elastomeric seal structure has an approximate amount of deformation.

In one of the possible or preferred embodiments, before the sealing element is pressed by the surrounding concave position-limiting portion, the elastomeric seal structure of the sealing element has an outer surrounding plane portion, and the outer surrounding plane portion of the elastomeric seal structure has an outer surrounding plane configured to correspond to the surrounding concave position-limiting portion.

In one of the possible or preferred embodiments, the oleophobic and high-temperature-resistant structure includes a plurality of oleophobic fillers each containing a predetermined oil-resistant material, and the oleophobic fillers are mixed into the elastomeric seal structure so as to form the sealing element having an oleophobic function.

In one of the possible or preferred embodiments, the predetermined oil-resistant material is selected from the group consisting of ethylene/acrylic elastomer, ethylene propylene diene rubber, tetrapropylene fluorine rubber, polyurethane rubber, acrylate rubber, fluoro rubber, butyl rubber, styrene-butadiene rubber, isoprene rubber and nitrile rubber, the fluorine rubber is fluorocarbon rubber, fluorosilicone rubber or fluoro-phosphazene rubber, and the nitrile rubber is hydrogenated nitrile rubber.

In one of the possible or preferred embodiments, the oleophobic and high-temperature-resistant structure of the sealing element is configured to reduce the corrosiveness of the elastomeric seal structure by an oil-containing cooling liquid.

Therefore, in the wound capacitor packaging structure and the sealing element thereof provided by the present disclosure, by virtue of “the sealing element being disposed inside the package casing and cooperating with the package casing, and the sealing element being configured to prevent the wound assembly from contacting an external environment” and “the sealing element including an elastomeric seal structure pressed by the surrounding concave position-limiting portion, and an oleophobic and high-temperature-resistant structure for protecting the elastomeric seal structure,” the oleophobic and high-temperature-resistant structure of the sealing element can be configured to enable the wound capacitor packaging structure to retain more than 93% of the predetermined initial capacitance when the wound capacitor packaging structure is powered off at a maximum temperature of 150° C. for less than 4,000 hours, and the oleophobic and high-temperature-resistant structure of the sealing element can be configured to enable the wound capacitor packaging structure to retain more than 85% of the predetermined initial capacitance when the wound capacitor packaging structure is powered on at a maximum temperature of 150° C. for less than 4,000 hours.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of the cooperation between the wound assembly and the conductive assembly of the wound capacitor packaging structure provided by a first embodiment of the present disclosure;

FIG. 2 is a partial schematic cross-sectional view of the wound capacitor packaging structure provided by the first embodiment of the present disclosure before the conductive assembly passes through the sealing element;

FIG. 3 is a partial schematic cross-sectional view of the wound assembly and the sealing element of the wound capacitor packaging structure provided by the first embodiment of the present disclosure after the wound assembly and the sealing element are put into the package casing;

FIG. 4 is a partial schematic cross-sectional view of the wound capacitor packaging structure provided by the first embodiment of the present disclosure;

FIG. 5 is a schematic enlarged view of part V of FIG. 4;

FIG. 6 is a schematic view of the wound capacitor packaging structure provided by the first embodiment of the present disclosure immersed in an oil-containing cooling liquid;

FIG. 7 is a partial schematic cross-sectional view of the wound capacitor packaging structure provided by a second embodiment of the present disclosure before the conductive assembly passes through the sealing element;

FIG. 8 is a partial schematic cross-sectional view of the wound capacitor packaging structure provided by a third embodiment of the present disclosure before the conductive assembly passes through the sealing element;

FIG. 9 is a partial schematic cross-sectional view of the wound capacitor packaging structure provided by a fourth embodiment of the present disclosure before the conductive assembly passes through the sealing element;

FIG. 10 is a partial schematic cross-sectional view of the wound capacitor packaging structure provided by a fifth embodiment of the present disclosure before the conductive assembly passes through the sealing element;

FIG. 11 is a partial schematic cross-sectional view of the wound capacitor packaging structure provided by a sixth embodiment of the present disclosure before the conductive assembly passes through the sealing element;

FIG. 12 is a partial schematic cross-sectional view of the wound capacitor packaging structure provided by a seventh embodiment of the present disclosure before the conductive assembly passes through the sealing element; and

FIG. 13 is a partial schematic cross-sectional view of the wound capacitor packaging structure provided by an eighth embodiment of the present disclosure before the conductive assembly passes through the sealing element.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

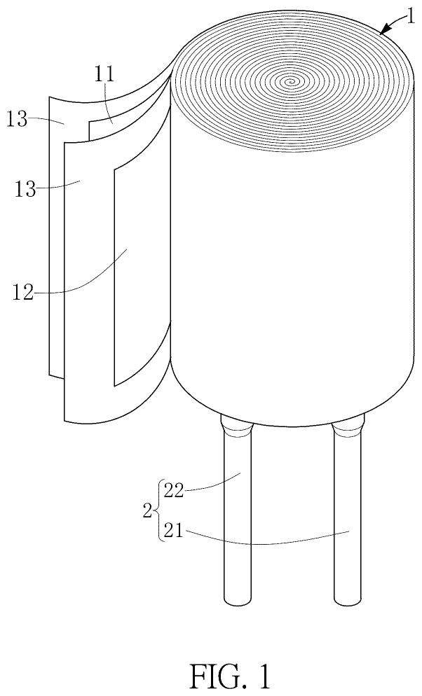

Referring to FIG. 1 to FIG. 6, a first embodiment of the present disclosure provides a method of manufacturing a wound capacitor packaging structure S (i.e., a winding-type capacitor packaging structure), which includes a wound assembly 1, a conductive assembly 2, a package casing 3 (or an encapsulating casing) and a sealing element 4 (or a sealing component). It should be noted that the wound capacitor packaging structure S can be configured to provide a predetermined initial capacitance (or an original set capacitance of the product when it leaves the factory).

Firstly, as shown in FIG. 1, the wound assembly 1 includes a wound positive conductive foil 11, a wound negative conductive foil 12 and two wound insulating separators 13. More particularly, one of the two wound insulating separators 13 is disposed between the wound positive conductive foil 11 and the wound negative conductive foil 12, and one of the wound positive conductive foil 11 and the wound negative conductive foil 12 is disposed between the two wound insulating separators 13 (for example, as shown in FIG. 1, the wound positive conductive foil 11 is disposed between the two wound insulating separators 13). In addition, the wound insulating separator 13 may be an insulating paper or insulating foil containing a dipping material such as a conductive polymer. However, the aforementioned details are disclosed for exemplary purposes only, and are not meant to limit the scope of the present disclosure.

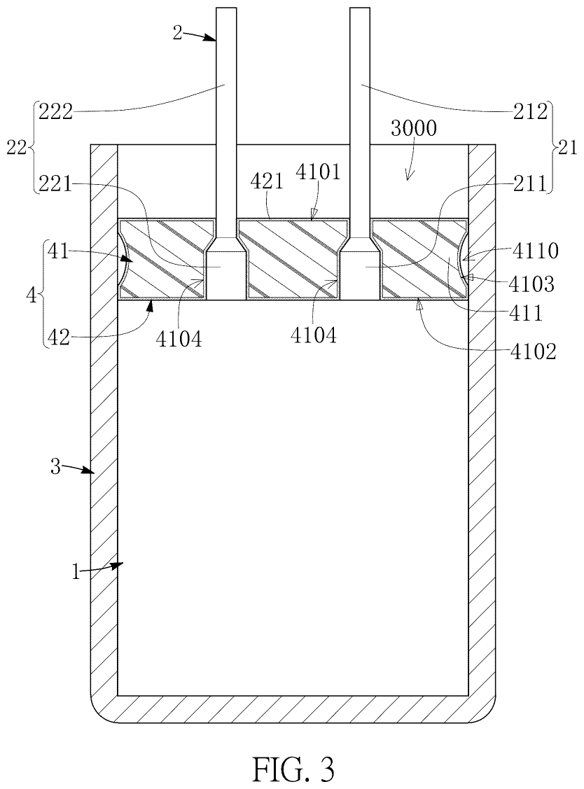

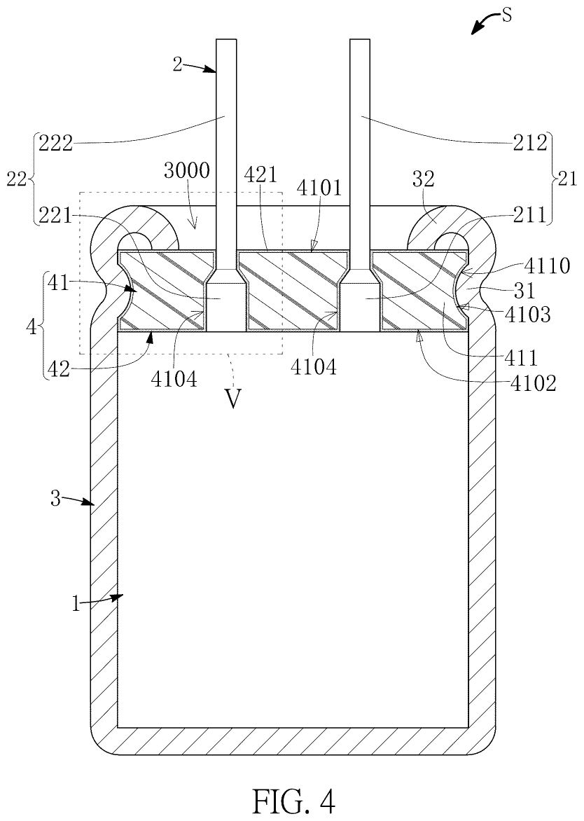

Furthermore, referring to FIG. 3 and FIG. 4, the conductive assembly 2 includes a first conductive pin 21 electrically contacting the wound positive conductive foil 11 and a second conductive pin 22 electrically contacting the wound negative conductive foil 12. For example, the first conductive pin 21 includes a first embedded portion 211 accommodated inside the package casing 3 and enclosed by the sealing element 4, and a first exposed portion 212 exposed outside or from the package casing 3, and the second conductive pin 22 includes a second embedded portion 221 accommodated inside the package casing 3 and enclosed by the sealing element 4, and a second exposed portion 222 exposed outside or from the package casing 3. However, the aforementioned details are disclosed for exemplary purposes only, and are not meant to limit the scope of the present disclosure.

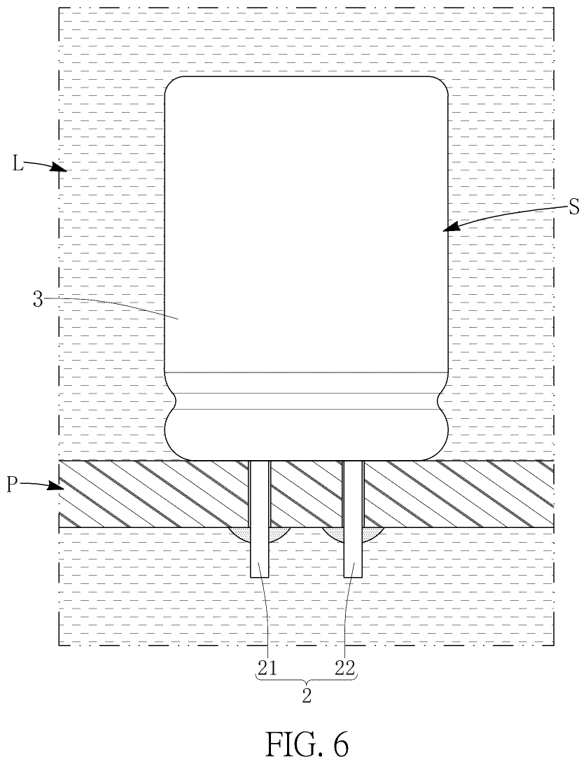

Moreover, referring to FIG. 3, FIG. 4 and FIG. 6, the package casing 3 can be configured to receive the wound assembly 1, and the sealing element 4 can be disposed inside the package casing 3 and cooperate with the package casing 3, and the sealing element 4 can be configured to prevent the wound assembly 1 from contacting an external environment (or the sealing element 4 can be configured as a barrier to avoid contact between the wound assembly 1 and the external environment). For example, referring to FIG. 3 and FIG. 4, the package casing 3 has an opening 3000, and the sealing element 4 can be disposed at the opening 3000 of the package casing 3 so as to close (or completely cover) the opening 3000 of the package casing 3. As shown in FIG. 4, after the sealing element 4 is pressed by the package casing 3, the package casing 3 has a surrounding concave position-limiting portion 31 that is recessed inward to press the sealing element 4, and a surrounding convex end portion 32 that is protruding from the surrounding concave position-limiting portion 31 to abut against the sealing element 4. In addition, the sealing element 4 includes an elastomeric seal structure 41 (or an elastic sealing structure) pressed by the surrounding concave position-limiting portion 31, and an oleophobic and high-temperature-resistant structure 42 for protecting the elastomeric seal structure 41. As shown in FIG. 6, when the wound capacitor packaging structure S that is soldered on a circuit substrate P is immersed in an oil-containing cooling liquid L (such as any oily cooling liquid, any cooling liquid or any coolant that can be used in immersion cooling technology), the oleophobic and high-temperature-resistant structure 42 of the sealing element 4 can be configured to reduce the corrosiveness of the elastomeric seal structure 41 by the oil-containing cooling liquid L. The oleophobic and high-temperature-resistant structure 42 of the sealing element 4 can be configured to enable or allow the wound capacitor packaging structure S to retain or keep more than 93% (such as any positive integer percentage between 93 percent and 100 percent) of the predetermined initial capacitance (referring to the experimental data in Tables 1 and 2 below) when the wound capacitor packaging structure S is powered off (placed or left standing without power) at a maximum temperature of 150° C. for less than or equal to 4,000 hours (that is to say, when the wound capacitor packaging structure S is powered off within 4,000 hours at a maximum temperature of 150° C.). The oleophobic and high-temperature-resistant structure 42 of the sealing element 4 can be configured to enable or allow the wound capacitor packaging structure S to retain or keep more than 85% (such as any positive integer percentage between 85 percent and 100 percent) of the predetermined initial capacitance (referring to the experimental data in Tables 3 and 4 below) when the wound capacitor packaging structure S is powered on (or energized, or electrically loaded) at a maximum temperature of 150° C. for less than or equal to 4,000 hours (that is to say, when the wound capacitor packaging structure S is powered on within 4,000 hours at a maximum temperature of 150° C.). It should be noted that, for the solid capacitor (as shown in Table 1 below), the wound capacitor packaging structure S can still retain 100% of the predetermined initial capacitance when the wound capacitor packaging structure S is powered off at the maximum temperature of 150° C. for 100 hours, and the wound capacitor packaging structure S can still retain 93.1% of the predetermined initial capacitance when the wound capacitor packaging structure S is powered off at the maximum temperature of 150° C. for 4,000 hours. In addition, for the solid-liquid hybrid capacitor (as shown in Table 2 below), the wound capacitor packaging structure S can still retain 100% of the predetermined initial capacitance when the wound capacitor packaging structure S is powered off at the maximum temperature of 150° C. for 100 hours, and the wound capacitor packaging structure S can still retain 97.3% of the predetermined initial capacitance when the wound capacitor packaging structure S is powered off at the maximum temperature of 150° C. for 4,000 hours. Furthermore, for the solid capacitor (as shown in Table 3 below), the wound capacitor packaging structure S can still retain 100% of the predetermined initial capacitance when the wound capacitor packaging structure S is powered on at the maximum temperature of 150° C. for 100 hours, and the wound capacitor packaging structure S can still retain 87.2% of the predetermined initial capacitance when the wound capacitor packaging structure S is powered on at the maximum temperature of 150° C. for 4,000 hours. In addition, for the solid-liquid hybrid capacitor (as shown in Table 4 below), the wound capacitor packaging structure S can still retain 100% of the predetermined initial capacitance when the wound capacitor packaging structure S is powered on at the maximum temperature of 150° C. for 100 hours, and the wound capacitor packaging structure S can still retain 85.3% of the predetermined initial capacitance when the wound capacitor packaging structure S is powered on at the maximum temperature of 150° C. for 4,000 hours. However, the aforementioned details are disclosed for exemplary purposes only, and are not meant to limit the scope of the present disclosure.

TABLE 1
Solid capacitor

| Power-off temperature | | | | | | |
|---|---|---|---|---|---|---|
| and hours (h) | Cap | DF | ESR | LC | CAP(%) | ESR(%) |
| power off at room | 646.9 | 2.15 | 7.23 | 34.2 | | |
| temperature | | | | | | |
| power off at 150° C. | 646.9 | 2.11 | 7.40 | 34.4 | 0.0% | 2.4% |
| for 100 h | | | | | | |
| power off at 150° C. | 647.8 | 2.11 | 7.37 | 36.2 | 0.1% | 1.9% |
| for 300 h | | | | | | |
| power off at 150° C. | 647.3 | 2.11 | 7.29 | 35.1 | 0.1% | 0.9% |
| for 500 h | | | | | | |
| power off at 150° C. | 644.1 | 2.17 | 7.31 | 33.7 | −0.4% | 1.1% |
| for 750 h | | | | | | |
| power off at 150° C. | 644.4 | 2.15 | 7.38 | 32.0 | −0.4% | 2.0% |
| for 1000 h | | | | | | |
| power off at 150° C. | 644.3 | 2.25 | 7.54 | 33.1 | −0.4% | 4.3% |
| for 1500 h | | | | | | |
| power off at 150° C. | 638.7 | 2.42 | 7.70 | 31.9 | −1.3% | 6.5% |
| for 2000 h | | | | | | |
| power off at 150° C. | 634.3 | 2.60 | 7.76 | 54.2 | −1.9% | 7.4% |
| for 2500 h | | | | | | |
| power off at 150° C. | 632.1 | 2.91 | 8.26 | 33.3 | −2.3% | 14.3% |
| for 3000 h | | | | | | |
| power off at 150° C. | 619.9 | 3.61 | 8.08 | 34.2 | −4.2% | 11.8% |
| for 3500 h | | | | | | |
| power off at 150° C. | 602.5 | 5.77 | 12.00 | 13.1 | −6.9% | 13.7% |
| for 4000 h | | | | | | |

TABLE 2
Solid-liquid hybrid capacitor

| Power-off temperature | | | | | | |
|---|---|---|---|---|---|---|
| and hours (h) | Cap | DF | ESR | LC | CAP(%) | ESR(%) |
| power off at room | 650.5 | 2.36 | 8.33 | 100.7 | | |
| temperature | | | | | | |
| power off at 150° C. | 650.5 | 2.52 | 9.05 | 47.7 | 0.0% | 8.7% |
| for 100 h | | | | | | |
| power off at 150° C. | 648.3 | 2.55 | 9.13 | 43.6 | −0.3% | 9.7% |
| for 300 h | | | | | | |
| power off at 150° C. | 647.0 | 2.38 | 8.67 | 37.0 | −0.5% | 4.1% |
| for 500 h | | | | | | |
| power off at 150° C. | 643.6 | 2.55 | 9.04 | 37.6 | −1.1% | 8.6% |
| for 750 h | | | | | | |
| power off at 150° C. | 644.8 | 2.40 | 8.74 | 33.7 | −0.9% | 5.0% |
| for 1000 h | | | | | | |
| power off at 150° C. | 644.4 | 2.62 | 9.35 | 34.1 | −0.9% | 12.3% |
| for 1500 h | | | | | | |
| power off at 150° C. | 640.9 | 2.76 | 9.67 | 32.9 | −1.5% | 16.1% |
| for 2000 h | | | | | | |
| power off at 150° C. | 637.5 | 2.90 | 9.98 | 33.6 | −2.0% | 19.9% |
| for 2500 h | | | | | | |
| power off at 150° C. | 636.5 | 3.11 | 11.00 | 33.9 | −2.1% | 32.1% |
| for 3000 h | | | | | | |
| power off at 150° C. | 635.8 | 3.17 | 10.86 | 31.7 | −2.3% | 30.4% |
| for 3500 h | | | | | | |
| power off at 150° C. | 632.8 | 3.16 | 11.07 | 11.6 | −2.7% | 33.0% |
| for 4000 h | | | | | | |

TABLE 3
Solid capacitor

| Power-on temperature | | | | | | |
|---|---|---|---|---|---|---|
| and hours (h) | Cap | DF | ESR | LC | CAP(%) | ESR(%) |
| power on at room | 645.7 | 2.34 | 7.43 | 37.7 | | |
| temperature | | | | | | |
| power on at 150° C. | 659.9 | 2.72 | 7.59 | 27.9 | 2.2% | 2.0% |
| for 100 h | | | | | | |
| power on at 150° C. | 656.4 | 2.81 | 7.53 | 34.9 | 1.7% | 1.3% |
| for 300 h | | | | | | |
| power on at 150° C. | 650.7 | 3.06 | 7.62 | 33.8 | 0.8% | 2.6% |
| for 500 h | | | | | | |
| power on at 150° C. | 638.4 | 3.57 | 7.85 | 30.6 | −1.1% | 5.6% |
| for 750 h | | | | | | |
| power on at 150° C. | 634.0 | 3.58 | 7.82 | 33.8 | −1.8% | 5.2% |
| for 1000 h | | | | | | |
| power on at 150° C. | 617.9 | 4.20 | 8.31 | 33.6 | −4.3% | 11.7% |
| for 1500 h | | | | | | |
| power on at 150° C. | 592.3 | 4.44 | 8.47 | 44.4 | −8.3% | 13.9% |
| for 2000 h | | | | | | |
| power on at 150° C. | 594.3 | 4.70 | 9.19 | 35.0 | −8.0% | 23.6% |
| for 2500 h | | | | | | |
| power on at 150° C. | 577.6 | 4.86 | 9.54 | 41.9 | −10.6% | 28.4% |
| for 3000 h | | | | | | |
| power on at 150° C. | 567.2 | 5.21 | 10.81 | 43.5 | −12.2% | 45.4% |
| for 3500 h | | | | | | |
| power on at 150° C. | 562.9 | 5.77 | 12.00 | 16.8 | −12.8% | 61.4% |
| for 4000 h | | | | | | |

TABLE 4
Solid-liquid hybrid capacitor

| Power-on temperature | | | | | | |
|---|---|---|---|---|---|---|
| and hours (h) | Cap | DF | ESR | LC | CAP(%) | ESR(%) |
| power on at room | 649.5 | 2.61 | 8.22 | 45.2 | | |
| temperature | | | | | | |
| power on at 150° C. | 658.9 | 3.12 | 9.15 | 29.2 | 1.4% | 11.4% |
| for 100 h | | | | | | |
| power on at 150° C. | 658.4 | 3.24 | 9.31 | 35.1 | 1.4% | 13.3% |
| for 300 h | | | | | | |
| power on at 150° C. | 658.1 | 3.11 | 8.84 | 34.3 | 1.3% | 7.6% |
| for 500 h | | | | | | |
| power on at 150° C. | 655.4 | 3.37 | 9.26 | 30.7 | 0.9% | 12.7% |
| for 750 h | | | | | | |
| power on at 150° C. | 654.5 | 3.24 | 9.06 | 33.4 | 0.8% | 10.3% |
| for 1000 h | | | | | | |
| power on at 150° C. | 650.9 | 3.56 | 9.68 | 35.4 | 0.2% | 17.8% |
| for 1500 h | | | | | | |
| power on at 150° C. | 640.4 | 3.51 | 9.66 | 42.3 | −1.4% | 17.6% |
| for 2000 h | | | | | | |
| power on at 150° C. | 641.3 | 3.97 | 10.01 | 31.0 | −1.3% | 21.9% |
| for 2500 h | | | | | | |
| power on at 150° C. | 629.6 | 4.47 | 10.24 | 33.2 | −3.1% | 24.7% |
| for 3000 h | | | | | | |
| power on at 150° C. | 604.1 | 5.74 | 11.13 | 39.5 | −7.0% | 35.5% |
| for 3500 h | | | | | | |
| power on at 150° C. | 554.2 | 7.79 | 12.34 | 15.7 | −14.7% | 50.1% |
| for 4000 h | | | | | | |

In the experimental data in the aforementioned Tables 1, 2, 3 and 4, Cap is the capacitance (μF) or the electrostatic capacity, DF is the dissipation factor (%) or the loss tangent (tan δ), ESR is the equivalent series resistance (mΩ), LC is the leakage current (μA), CAP (%) is the percentage difference from “the Cap value when powering off or on at room temperature,” and ESR (%) is the percentage difference from “the ESR value when powering off or on at room temperature.”

It should be noted that referring to FIG. 3, FIG. 4 and FIG. 6, the elastomeric seal structure 41 has an upper surface 4101 facing away from the wound assembly 1, a lower surface 4102 facing the wound assembly 1, an outer surrounding surface 4103 connected between the upper surface 4101 and the lower surface 4102, and at least two through holes 4104 connected between the upper surface 4101 and the lower surface 4102, and the oleophobic and high-temperature-resistant structure 42 includes an oleophobic and high-temperature-resistant structural layer 421 containing a predetermined oil-resistant material. Therefore, when the upper surface 4101, the lower surface 4102 and the outer surrounding surface 4103 of the elastomeric seal structure 41 are covered by the oleophobic and high-temperature-resistant structural layer 421, the elastomeric seal structure 41 can be completely covered or enclosed by the oleophobic and high-temperature-resistant structural layer 421, thereby preventing the upper surface 4101, the lower surface 4102 and the outer surrounding surface 4103 of the elastomeric seal structure 41 from contacting the oil-containing cooling liquid L (specifically refers to the corrosive and high-temperature oil-containing coolant) so as to reduce the corrosiveness of the elastomeric seal structure 41 by the oil-containing cooling liquid L, and also reducing the decay rate (or the attenuation degree) of the electrical characteristics of the wound capacitor packaging structure S. It is worth noting that the inner surface of each through hole 4104 of the elastomeric seal structure 41 can also be covered by the oleophobic and high-temperature-resistant structural layer 421, so that the elastomeric seal structure 41 can be partially covered by the oleophobic and high-temperature-resistant structural layer 421, thereby preventing (or blocking) the inner surface of each through hole 4104 of the elastomeric seal structure 41 from contacting the oil-containing cooling liquid L.

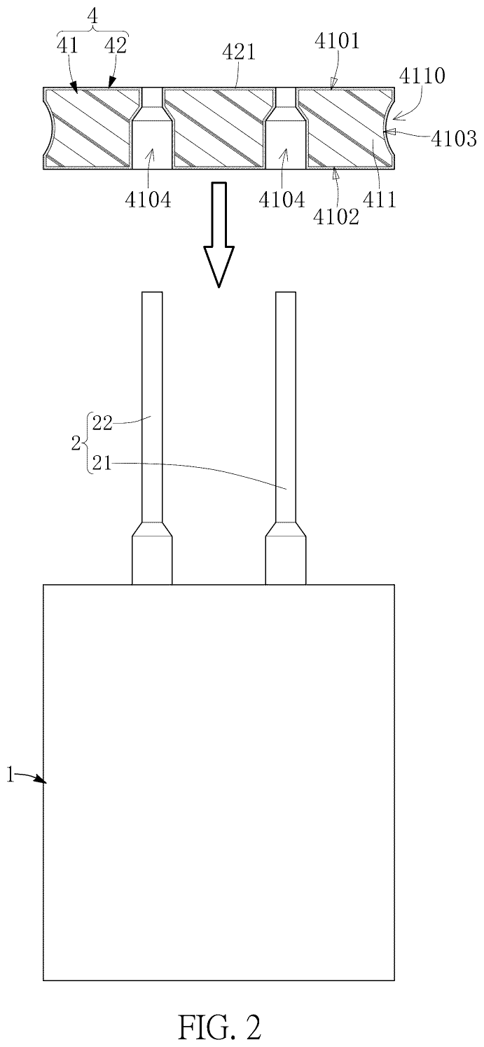

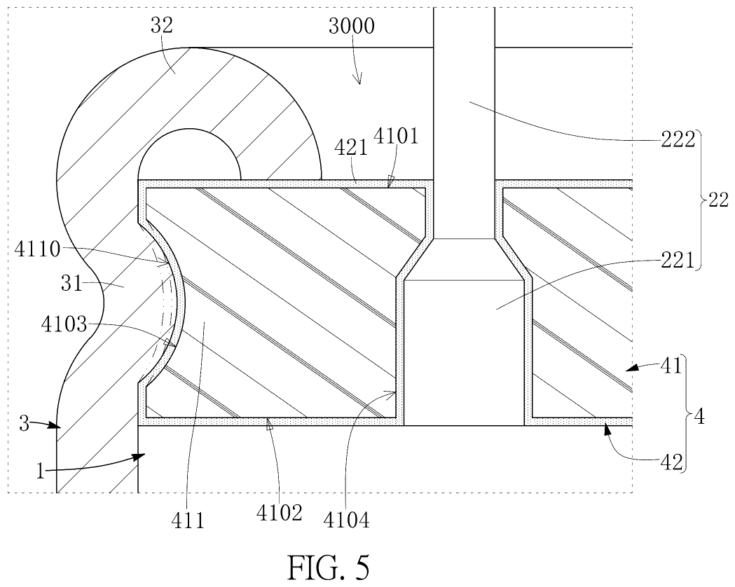

It should be noted that referring to FIG. 2 and FIG. 3, before the sealing element 4 is pressed by the surrounding concave position-limiting portion 31, the elastomeric seal structure 41 of the sealing element 4 has an outer surrounding concave portion 411, the outer surrounding concave portion 411 of the elastomeric seal structure 41 has an outer surrounding concave space 4110 configured to accommodate a part of the surrounding concave position-limiting portion 31, and a concave contour of the outer surrounding concave portion 411 of the elastomeric seal structure 41 and a concave contour of the surrounding concave position-limiting portion 31 of the package casing 3 correspond to (such as coincide with or are similar to) each other. Moreover, referring to FIG. 4 and FIG. 5, after the sealing element 4 is pressed by the surrounding concave position-limiting portion 31, a large part of the outer surrounding concave portion 411 of the elastomeric seal structure 41 is uniformly and surroundingly pressed by the surrounding concave position-limiting portion 31, so that an outer peripheral area of the outer surrounding concave portion 411 of the elastomeric seal structure 41 has an approximate amount of deformation. That is to say, since the elastomeric seal structure 41 can provide an outer surrounding concave portion 411 in advance, when the outer surrounding concave portion 411 of the sealing element 4 is pressed by the surrounding concave position-limiting portion 31 of the package casing 3, the outer surrounding concave portion 411 of the elastomeric seal structure 41 will not have too much deformation (i.e., the amount of change from the dotted line to the solid line as shown in FIG. 5, that is a very small amount of arc change), thereby avoiding structural damage to the outer surrounding concave portion 411 and avoiding reducing the sealing effect between the package casing 3 and the sealing element 4, and thereby lowering the structural damage (such as pin offset or pin bending) that may occur when the first conductive pin 21 and the second conductive pin 22 of the conductive assembly 2 are pressed by the surrounding concave position-limiting portion 31 of the package casing 3.

For example, the predetermined oil-resistant material can be selected from VAMAC rubber (ethylene/acrylic elastomer), EPDM rubber (ethylene propylene diene rubber), AFLAS rubber (tetrapropylene fluorine rubber), polyurethane rubber, acrylate rubber, fluoro rubber, butyl rubber, styrene-butadiene rubber, polyisoprene rubber (isoprene rubber) and nitrile butadiene rubber (nitrile rubber). That is to say, the predetermined oil-resistant material may include VAMAC rubber, EPDM rubber, AFLAS rubber, polyurethane rubber, acrylate rubber, fluoro rubber, butyl rubber, styrene-butadiene rubber, polyisoprene rubber, nitrile butadiene rubber or any material with oleophobicity. Furthermore, the fluoro rubber may be FKM (fluorocarbon) rubber, fluoro-silicone rubber (fluorosilicone rubber) or fluoro-phosphazene rubber, and the nitrile rubber may be hydrogenated nitrile rubber. However, the aforementioned details are disclosed for exemplary purposes only, and are not meant to limit the scope of the present disclosure.

For example, the predetermined oil-resistant material further includes a filler configured to adjust hardness, heat resistance and air tightness of the predetermined oil-resistant material, a bridging agent configured to initiate polymerization, an anti-aging agent configured for antioxidant and anti-aging purposes, and a processing aid configured for improving rubber flow, in which the filler includes carbon black or non-carbon black, the bridging agent includes sulfur or peroxide, and the processing aid includes processing oil or plasticizer. However, the aforementioned details are disclosed for exemplary purposes only, and are not meant to limit the scope of the present disclosure.

### Second Embodiment

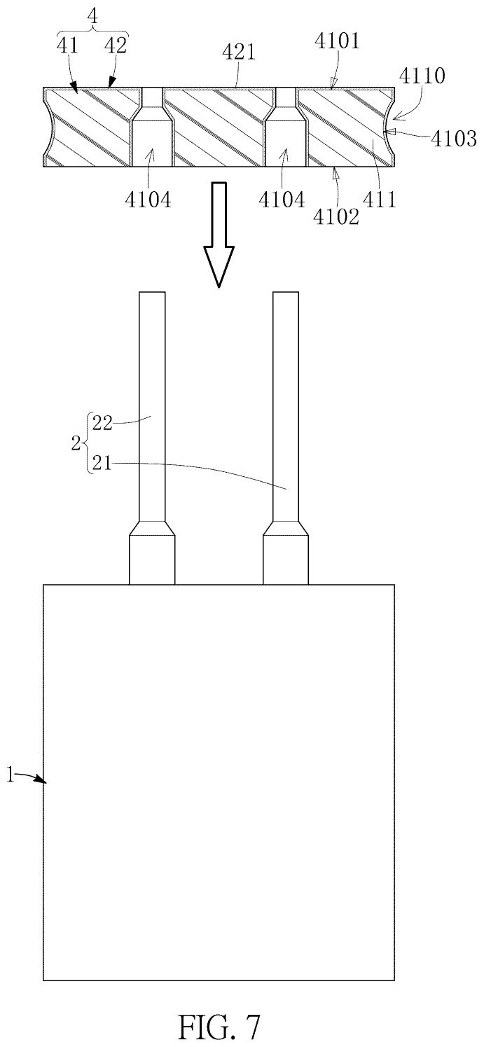

Referring to FIG. 7, a second embodiment of the present disclosure provides a sealing element 4 that can be applied to a wound capacitor packaging structure (not shown, but referring to the first embodiment). Comparing FIG. 7 with FIG. 2, the main difference between the second embodiment and the first embodiment is as follows: in the second embodiment, before the sealing element 4 is pressed by the surrounding concave position-limiting portion (not shown, but referring to the first embodiment), only the upper surface 4101 and the outer surrounding surface 4103 of the elastomeric seal structure 41 are covered by the oleophobic and high-temperature-resistant structural layer 421, so that the elastomeric seal structure 41 can be partially covered by the oleophobic and high-temperature-resistant structural layer 421, thereby preventing both the upper surface 4101 and the outer surrounding surface 4103 of the elastomeric seal structure 41 from contacting the oil-containing cooling liquid L (specifically refers to the corrosive and high-temperature oil-containing coolant) so as to reduce the corrosiveness of the elastomeric seal structure 41 by the oil-containing cooling liquid L, and also reducing the decay rate (or the attenuation degree) of the electrical characteristics of the wound capacitor packaging structure S. It is worth noting that the inner surface of each through hole 4104 of the elastomeric seal structure 41 can also be covered by the oleophobic and high-temperature-resistant structural layer 421, so that the elastomeric seal structure 41 can be partially covered by the oleophobic and high-temperature-resistant structural layer 421, thereby preventing (or blocking) the inner surface of each through hole 4104 of the elastomeric seal structure 41 from contacting the oil-containing cooling liquid L.

### Third Embodiment

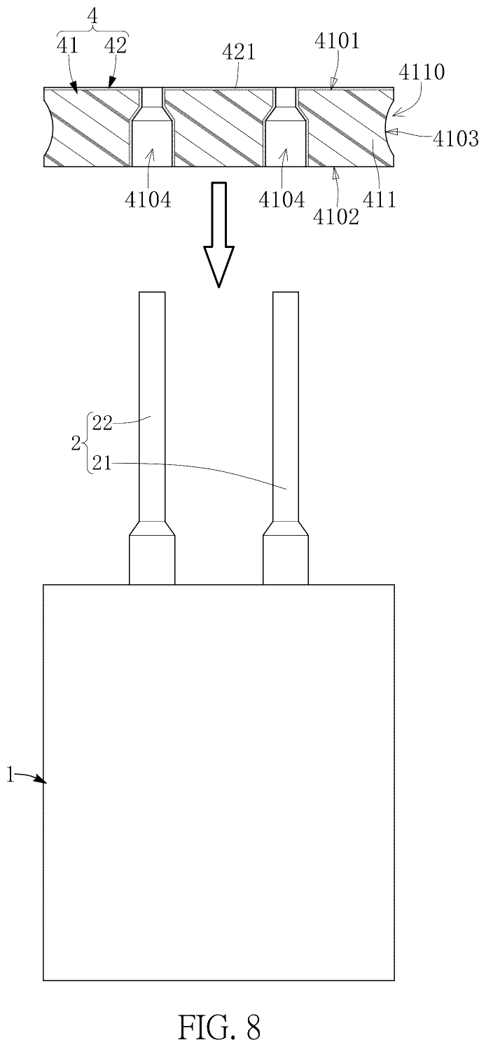

Referring to FIG. 8, a third embodiment of the present disclosure provides a sealing element 4 that can be applied to a wound capacitor packaging structure (not shown, but referring to the first embodiment). Comparing FIG. 8 with FIG. 2, the main difference between the third embodiment and the first embodiment is as follows: in the third embodiment, before the sealing element 4 is pressed by the surrounding concave position-limiting portion (not shown, but referring to the first embodiment), only the upper surface 4101 of the elastomeric seal structure 41 is covered by the oleophobic and high-temperature-resistant structural layer 421, so that the elastomeric seal structure 41 can be partially covered by the oleophobic and high-temperature-resistant structural layer 421, thereby preventing the upper surface 4101 of the elastomeric seal structure 41 from contacting the oil-containing cooling liquid L (specifically refers to the corrosive and high-temperature oil-containing coolant) so as to reduce the corrosiveness of the elastomeric seal structure 41 by the oil-containing cooling liquid L, and also reducing the decay rate (or the attenuation degree) of the electrical characteristics of the wound capacitor packaging structure S. It is worth noting that the inner surface of each through hole 4104 of the elastomeric seal structure 41 can also be covered by the oleophobic and high-temperature-resistant structural layer 421, so that the elastomeric seal structure 41 can be partially covered by the oleophobic and high-temperature-resistant structural layer 421, thereby preventing (or blocking) the inner surface of each through hole 4104 of the elastomeric seal structure 41 from contacting the oil-containing cooling liquid L.

### Fourth Embodiment

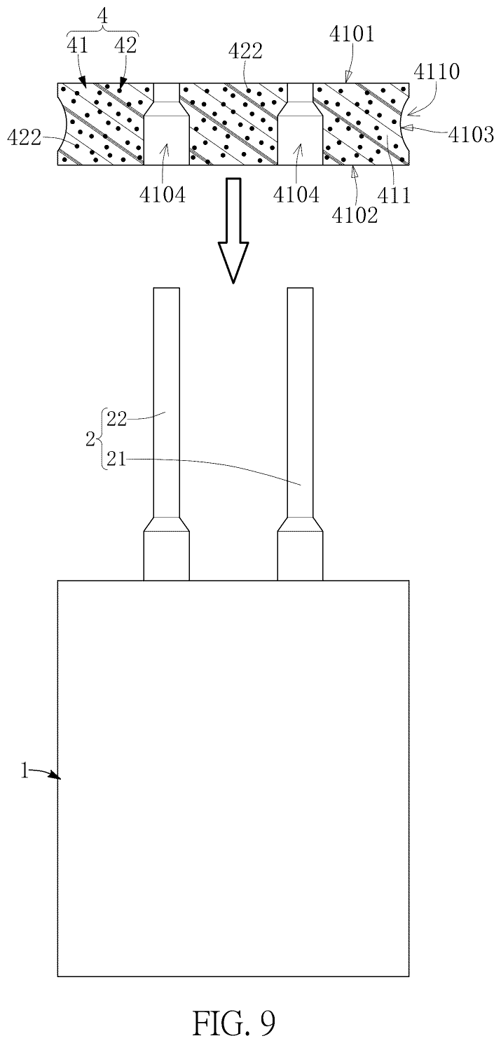

Referring to FIG. 9, a fourth embodiment of the present disclosure provides a sealing element 4 that can be applied to a wound capacitor packaging structure (not shown, but referring to the first embodiment). Comparing FIG. 9 with FIG. 2, the main difference between the fourth embodiment and the first embodiment is as follows: in the fourth embodiment, before the sealing element 4 is pressed by the surrounding concave position-limiting portion (not shown, but referring to the first embodiment), the oleophobic and high-temperature-resistant structure 42 includes a plurality of oleophobic fillers 422 each containing a predetermined oil-resistant material (such as oleophobic powder or oleophobic particles), and the oleophobic fillers 422 can be mixed into the elastomeric seal structure 41 so as to form the sealing element 4 having an oleophobic function, thereby preventing the elastomeric seal structure 41 from contacting the oil-containing cooling liquid L so as to reduce the corrosiveness of the elastomeric seal structure 41 by the oil-containing cooling liquid L.

### Fifth Embodiment

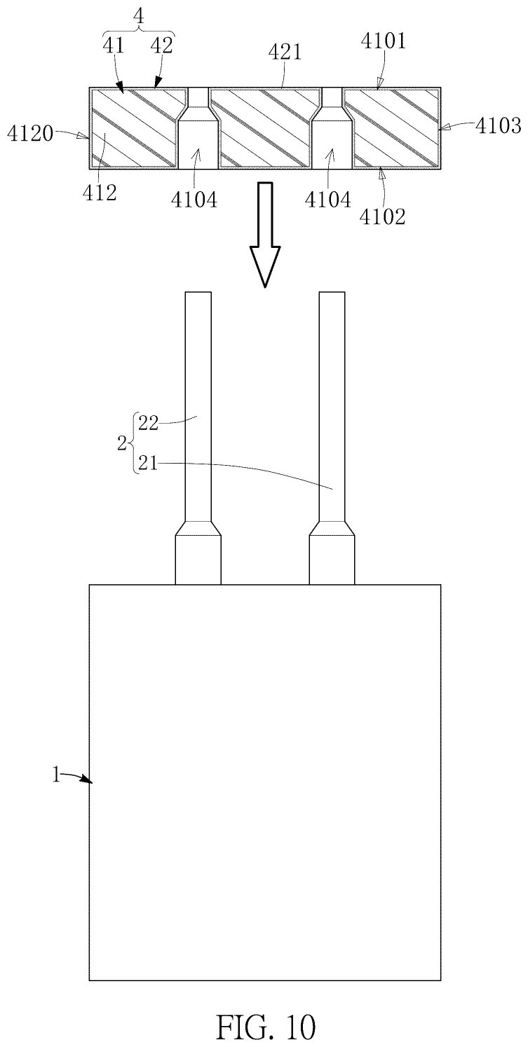

Referring to FIG. 10, a fifth embodiment of the present disclosure provides a sealing element 4 that can be applied to a wound capacitor packaging structure (not shown, but referring to the first embodiment). Comparing FIG. 10 with FIG. 2, the main difference between the fifth embodiment and the first embodiment is as follows: in the fifth embodiment, before the sealing element 4 is pressed by the surrounding concave position-limiting portion (not shown, but referring to the first embodiment), the elastomeric seal structure 41 of the sealing element 4 has an outer surrounding plane portion 412, and the outer surrounding plane portion 412 of the elastomeric seal structure 41 has an outer surrounding plane 4120 configured to correspond to the surrounding concave position-limiting portion (not shown, but referring to the first embodiment).

### Sixth Embodiment

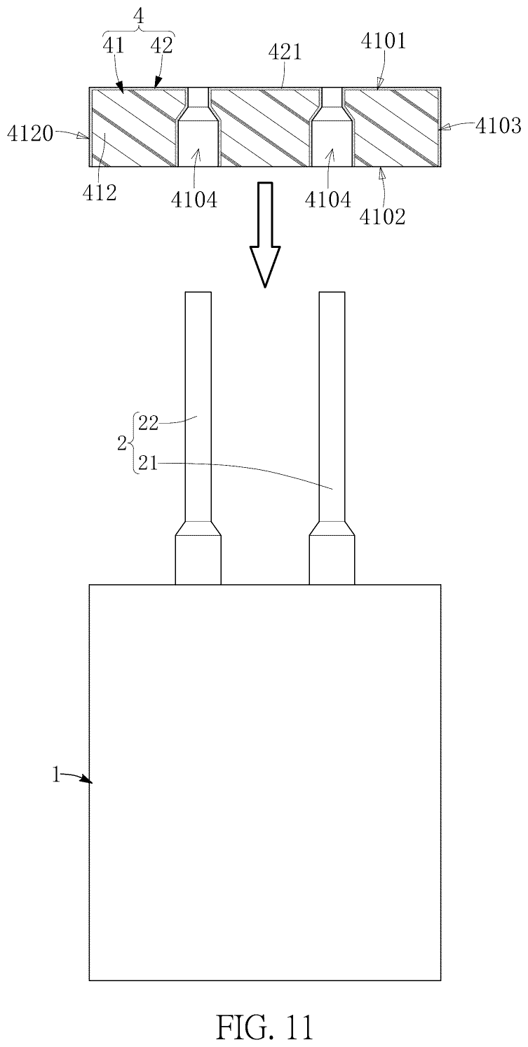

Referring to FIG. 11, a sixth embodiment of the present disclosure provides a sealing element 4 that can be applied to a wound capacitor packaging structure (not shown, but referring to the first embodiment). Comparing FIG. 11 with FIG. 7, the main difference between the sixth embodiment and the second embodiment is as follows: in the sixth embodiment, before the sealing element 4 is pressed by the surrounding concave position-limiting portion (not shown, but referring to the first embodiment), the elastomeric seal structure 41 of the sealing element 4 has an outer surrounding plane portion 412, and the outer surrounding plane portion 412 of the elastomeric seal structure 41 has an outer surrounding plane 4120 configured to correspond to the surrounding concave position-limiting portion (not shown, but referring to the first embodiment).

### Seventh Embodiment

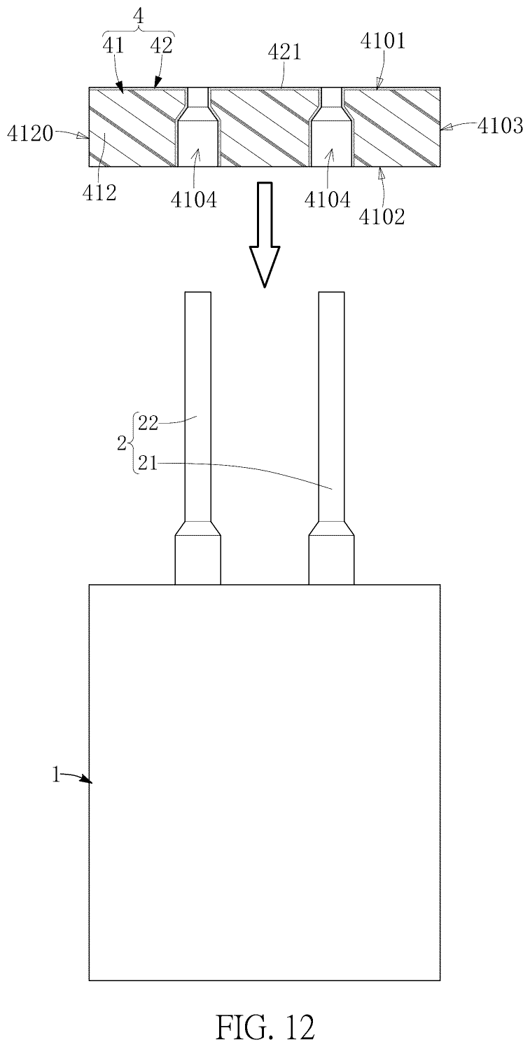

Referring to FIG. 12, a seventh embodiment of the present disclosure provides a sealing element 4 that can be applied to a wound capacitor packaging structure (not shown, but referring to the first embodiment). Comparing FIG. 12 with FIG. 8, the main difference between the seventh embodiment and the third embodiment is as follows: in the seventh embodiment, before the sealing element 4 is pressed by the surrounding concave position-limiting portion (not shown, but referring to the first embodiment), the elastomeric seal structure 41 of the sealing element 4 has an outer surrounding plane portion 412, and the outer surrounding plane portion 412 of the elastomeric seal structure 41 has an outer surrounding plane 4120 configured to correspond to the surrounding concave position-limiting portion (not shown, but referring to the first embodiment).

### Eighth Embodiment

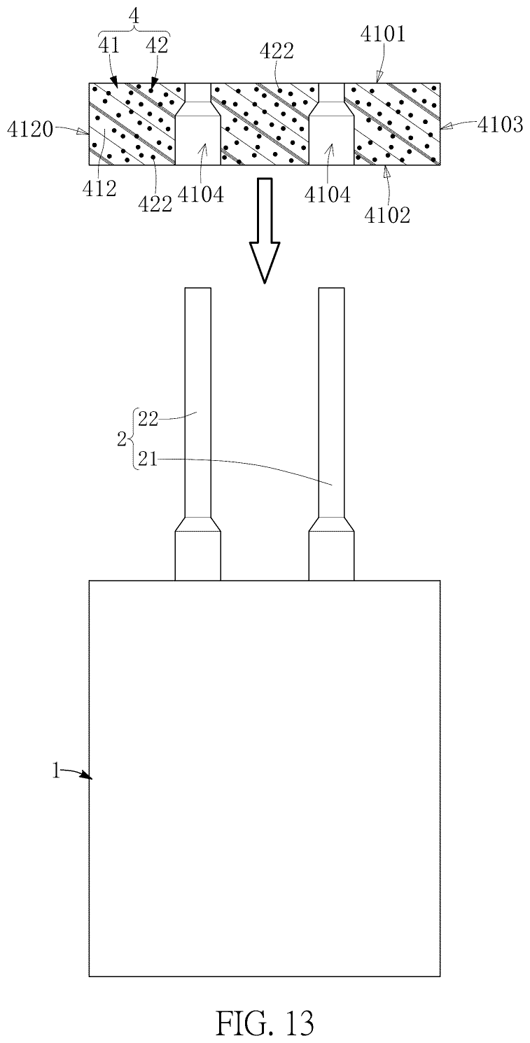

Referring to FIG. 13, an eighth embodiment of the present disclosure provides a sealing element 4 that can be applied to a wound capacitor packaging structure (not shown, but referring to the first embodiment). Comparing FIG. 13 with FIG. 9, the main difference between the eighth embodiment and the fourth embodiment is as follows: in the eighth embodiment, before the sealing element 4 is pressed by the surrounding concave position-limiting portion (not shown, but referring to the first embodiment), the elastomeric seal structure 41 of the sealing element 4 has an outer surrounding plane portion 412, and the outer surrounding plane portion 412 of the elastomeric seal structure 41 has an outer surrounding plane 4120 configured to correspond to the surrounding concave position-limiting portion (not shown, but referring to the first embodiment).

### Beneficial Effects of the Embodiments

In conclusion, in the wound capacitor packaging structure S and the sealing element 4 thereof provided by the present disclosure, by virtue of “the sealing element 4 being disposed inside the package casing 3 and cooperating with the package casing 3, and the sealing element 4 being configured to prevent the wound assembly 1 from contacting an external environment” and “the sealing element 4 including an elastomeric seal structure 41 pressed by the surrounding concave position-limiting portion 31, and an oleophobic and high-temperature-resistant structure 42 for protecting the elastomeric seal structure 41,” the oleophobic and high-temperature-resistant structure 42 of the sealing element 4 can be configured to enable or allow the wound capacitor packaging structure S to retain or keep more than 93% of the predetermined initial capacitance when the wound capacitor packaging structure S is powered off at a maximum temperature of 150° C. for less than 4,000 hours, and the oleophobic and high-temperature-resistant structure 42 of the sealing element 4 can be configured to enable or allow the wound capacitor packaging structure S to retain or keep more than 85% of the predetermined initial capacitance when the wound capacitor packaging structure S is powered on at a maximum temperature of 150° C. for less than 4,000 hours.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A wound capacitor packaging structure, comprising:
a wound assembly including a wound positive conductive foil, a wound negative conductive foil and two wound insulating separators;
a conductive assembly including a first conductive pin electrically contacting the wound positive conductive foil and a second conductive pin electrically contacting the wound negative conductive foil;
a package casing configured to receive the wound assembly; and
a sealing element disposed inside the package casing and cooperating with the package casing, wherein the sealing element is configured to prevent the wound assembly from contacting an external environment;
wherein one of the two wound insulating separators is disposed between the wound positive conductive foil and the wound negative conductive foil, and one of the wound positive conductive foil and the wound negative conductive foil is disposed between the two wound insulating separators;
wherein the first conductive pin includes a first embedded portion accommodated inside the package casing and enclosed by the sealing element, and a first exposed portion exposed outside the package casing, and the second conductive pin includes a second embedded portion accommodated inside the package casing and enclosed by the sealing element, and a second exposed portion exposed outside the package casing;
wherein the package casing has a surrounding concave position-limiting portion recessed inward to press the sealing element, and a surrounding convex end portion protruding from the surrounding concave position-limiting portion to abut against the sealing element;
wherein the sealing element includes an elastomeric seal structure pressed by the surrounding concave position-limiting portion, and an oleophobic and high-temperature-resistant structure for protecting the elastomeric seal structure; and
wherein the wound capacitor packaging structure is configured to provide a predetermined initial capacitance, the oleophobic and high-temperature-resistant structure of the sealing element is configured to enable the wound capacitor packaging structure to retain more than 93% of the predetermined initial capacitance when the wound capacitor packaging structure is powered off at a maximum temperature of 150° C. for less than 4,000 hours, and the oleophobic and high-temperature-resistant structure of the sealing element is configured to enable the wound capacitor packaging structure to retain more than 85% of the predetermined initial capacitance when the wound capacitor packaging structure is powered on at a maximum temperature of 150° C. for less than 4,000 hours.

2. The wound capacitor packaging structure according to claim 1,
wherein the oleophobic and high-temperature-resistant structure of the sealing element is configured to reduce the corrosiveness of the elastomeric seal structure by an oil-containing cooling liquid;
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, an outer surrounding surface connected between the upper surface and the lower surface, and at least two through holes connected between the upper surface and the lower surface, and the oleophobic and high-temperature-resistant structure includes an oleophobic and high-temperature-resistant structural layer containing a predetermined oil-resistant material;
wherein, when the upper surface, the lower surface and the outer surrounding surface of the elastomeric seal structure are covered by the oleophobic and high-temperature-resistant structural layer, the elastomeric seal structure is completely covered by the oleophobic and high-temperature-resistant structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic and high-temperature-resistant structural layer, the elastomeric seal structure is partially covered by the oleophobic and high-temperature-resistant structural layer, thereby preventing both the upper surface and the outer surrounding surface of the elastomeric seal structure from contacting the oil-containing cooling liquid;
wherein, when the upper surface of the elastomeric seal structure is covered by the oleophobic and high-temperature-resistant structural layer, the elastomeric seal structure is partially covered by the oleophobic and high-temperature-resistant structural layer, thereby preventing the upper surface of the elastomeric seal structure from contacting the oil-containing cooling liquid;
wherein, when an inner surface of each of the plurality of through holes of the elastomeric seal structure is covered by the oleophobic and high-temperature-resistant structural layer, the elastomeric seal structure is partially covered by the oleophobic and high-temperature-resistant structural layer, thereby preventing the inner surface of each of the plurality of through holes of the elastomeric seal structure from contacting the oil-containing cooling liquid;
wherein, before the sealing element is pressed by the surrounding concave position-limiting portion, the elastomeric seal structure of the sealing element has an outer surrounding concave portion, the outer surrounding concave portion of the elastomeric seal structure has an outer surrounding concave space configured to accommodate a part of the surrounding concave position-limiting portion, and a concave contour of the outer surrounding concave portion of the elastomeric seal structure and a concave contour of the surrounding concave position-limiting portion of the package casing correspond to each other;
wherein, after the sealing element is pressed by the surrounding concave position-limiting portion, a large part of the outer surrounding concave portion of the elastomeric seal structure is uniformly pressed by the surrounding concave position-limiting portion, so that an outer peripheral area of the outer surrounding concave portion of the elastomeric seal structure has an approximate amount of deformation;
wherein the predetermined oil-resistant material is selected from the group consisting of ethylene/acrylic elastomer, ethylene propylene diene rubber, tetrapropylene fluorine rubber, polyurethane rubber, acrylate rubber, fluoro rubber, butyl rubber, styrene-butadiene rubber, isoprene rubber and nitrile rubber, the fluorine rubber is fluorocarbon rubber, fluorosilicone rubber or fluoro-phosphazene rubber, and the nitrile rubber is hydrogenated nitrile rubber; and
wherein the predetermined oil-resistant material further includes a filler configured to adjust hardness, heat resistance and air tightness, a bridging agent configured to initiate polymerization, an anti-aging agent configured for antioxidant and anti-aging, and a processing aid configured for improving rubber flow, the filler includes carbon black or non-carbon black, the bridging agent includes sulfur or peroxide, and the processing aid includes processing oil or plasticizer.

3. The wound capacitor packaging structure according to claim 1,
wherein the oleophobic and high-temperature-resistant structure of the sealing element is configured to reduce the corrosiveness of the elastomeric seal structure by an oil-containing cooling liquid;
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, an outer surrounding surface connected between the upper surface and the lower surface, and at least two through holes connected between the upper surface and the lower surface, and the oleophobic and high-temperature-resistant structure includes an oleophobic and high-temperature-resistant structural layer containing a predetermined oil-resistant material;
wherein, when the upper surface, the lower surface and the outer surrounding surface of the elastomeric seal structure are covered by the oleophobic and high-temperature-resistant structural layer, the elastomeric seal structure is completely covered by the oleophobic and high-temperature-resistant structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic and high-temperature-resistant structural layer, the elastomeric seal structure is partially covered by the oleophobic and high-temperature-resistant structural layer, thereby preventing both the upper surface and the outer surrounding surface of the elastomeric seal structure from contacting the oil-containing cooling liquid;
wherein, when the upper surface of the elastomeric seal structure is covered by the oleophobic and high-temperature-resistant structural layer, the elastomeric seal structure is partially covered by the oleophobic and high-temperature-resistant structural layer, thereby preventing the upper surface of the elastomeric seal structure from contacting the oil-containing cooling liquid;
wherein, when an inner surface of each of the plurality of through holes of the elastomeric seal structure is covered by the oleophobic and high-temperature-resistant structural layer, the elastomeric seal structure is partially covered by the oleophobic and high-temperature-resistant structural layer, thereby preventing the inner surface of each of the plurality of through holes of the elastomeric seal structure from contacting the oil-containing cooling liquid;
wherein, before the sealing element is pressed by the surrounding concave position-limiting portion, the elastomeric seal structure of the sealing element has an outer surrounding plane portion, and the outer surrounding plane portion of the elastomeric seal structure has an outer surrounding plane configured to correspond to the surrounding concave position-limiting portion;
wherein the predetermined oil-resistant material is selected from the group consisting of ethylene/acrylic elastomer, ethylene propylene diene rubber, tetrapropylene fluorine rubber, polyurethane rubber, acrylate rubber, fluoro rubber, butyl rubber, styrene-butadiene rubber, isoprene rubber and nitrile rubber, the fluorine rubber is fluorocarbon rubber, fluorosilicone rubber or fluoro-phosphazene rubber, and the nitrile rubber is hydrogenated nitrile rubber; and
wherein the predetermined oil-resistant material further includes a filler configured to adjust hardness, heat resistance and air tightness, a bridging agent configured to initiate polymerization, an anti-aging agent configured for antioxidant and anti-aging, and a processing aid configured for improving rubber flow, the filler includes carbon black or non-carbon black, the bridging agent includes sulfur or peroxide, and the processing aid includes processing oil or plasticizer.

4. The wound capacitor packaging structure according to claim 1,
wherein the oleophobic and high-temperature-resistant structure of the sealing element is configured to reduce the corrosiveness of the elastomeric seal structure by an oil-containing cooling liquid;
wherein the package casing has an opening, and the sealing element is configured to be disposed at the opening of the package casing so as to close the opening of the package casing;
wherein the oleophobic and high-temperature-resistant structure includes a plurality of oleophobic fillers each containing a predetermined oil-resistant material, and the oleophobic fillers are mixed into the elastomeric seal structure so as to form the sealing element having an oleophobic function;
wherein the predetermined oil-resistant material is selected from the group consisting of ethylene/acrylic elastomer, ethylene propylene diene rubber, tetrapropylene fluorine rubber, polyurethane rubber, acrylate rubber, fluoro rubber, butyl rubber, styrene-butadiene rubber, isoprene rubber and nitrile rubber, the fluorine rubber is fluorocarbon rubber, fluorosilicone rubber or fluoro-phosphazene rubber, and the nitrile rubber is hydrogenated nitrile rubber; and
wherein the predetermined oil-resistant material further includes a filler configured to adjust hardness, heat resistance and air tightness, a bridging agent configured to initiate polymerization, an anti-aging agent configured for antioxidant and anti-aging, and a processing aid configured for improving rubber flow, the filler includes carbon black or non-carbon black, the bridging agent includes sulfur or peroxide, and the processing aid includes processing oil or plasticizer.

5. A wound capacitor packaging structure, comprising:
a wound assembly;
a conductive assembly including a first conductive pin and a second conductive pin;
a package casing configured to receive the wound assembly; and
a sealing element disposed inside the package casing and cooperating with the package casing, wherein the sealing element is configured to prevent the wound assembly from contacting an external environment;
wherein the package casing has a surrounding concave position-limiting portion recessed inward to press the sealing element, and a surrounding convex end portion protruding from the surrounding concave position-limiting portion to abut against the sealing element;
wherein the sealing element includes an elastomeric seal structure pressed by the surrounding concave position-limiting portion, and an oleophobic and high-temperature-resistant structure for protecting the elastomeric seal structure; and
wherein the wound capacitor packaging structure is configured to provide a predetermined initial capacitance, the oleophobic and high-temperature-resistant structure of the sealing element is configured to enable the wound capacitor packaging structure to retain more than 93% of the predetermined initial capacitance when the wound capacitor packaging structure is powered off at a maximum temperature of 150° C. for less than 4,000 hours, and the oleophobic and high-temperature-resistant structure of the sealing element is configured to enable the wound capacitor packaging structure to retain more than 85% of the predetermined initial capacitance when the wound capacitor packaging structure is powered on at a maximum temperature of 150° C. for less than 4,000 hours.

6. The wound capacitor packaging structure according to claim 5,
wherein the oleophobic and high-temperature-resistant structure of the sealing element is configured to reduce the corrosiveness of the elastomeric seal structure by an oil-containing cooling liquid;
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, an outer surrounding surface connected between the upper surface and the lower surface, and at least two through holes connected between the upper surface and the lower surface, and the oleophobic and high-temperature-resistant structure includes an oleophobic and high-temperature-resistant structural layer containing a predetermined oil-resistant material;
wherein, when the upper surface, the lower surface and the outer surrounding surface of the elastomeric seal structure are covered by the oleophobic and high-temperature-resistant structural layer, the elastomeric seal structure is completely covered by the oleophobic and high-temperature-resistant structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic and high-temperature-resistant structural layer, the elastomeric seal structure is partially covered by the oleophobic and high-temperature-resistant structural layer, thereby preventing both the upper surface and the outer surrounding surface of the elastomeric seal structure from contacting the oil-containing cooling liquid;
wherein, when the upper surface of the elastomeric seal structure is covered by the oleophobic and high-temperature-resistant structural layer, the elastomeric seal structure is partially covered by the oleophobic and high-temperature-resistant structural layer, thereby preventing the upper surface of the elastomeric seal structure from contacting the oil-containing cooling liquid;
wherein, when an inner surface of each of the plurality of through holes of the elastomeric seal structure is covered by the oleophobic and high-temperature-resistant structural layer, the elastomeric seal structure is partially covered by the oleophobic and high-temperature-resistant structural layer, thereby preventing the inner surface of each of the plurality of through holes of the elastomeric seal structure from contacting the oil-containing cooling liquid;
wherein, before the sealing element is pressed by the surrounding concave position-limiting portion, the elastomeric seal structure of the sealing element has an outer surrounding concave portion, the outer surrounding concave portion of the elastomeric seal structure has an outer surrounding concave space configured to accommodate a part of the surrounding concave position-limiting portion, and a concave contour of the outer surrounding concave portion of the elastomeric seal structure and a concave contour of the surrounding concave position-limiting portion of the package casing correspond to each other;
wherein, after the sealing element is pressed by the surrounding concave position-limiting portion, a large part of the outer surrounding concave portion of the elastomeric seal structure is uniformly pressed by the surrounding concave position-limiting portion, so that an outer peripheral area of the outer surrounding concave portion of the elastomeric seal structure has an approximate amount of deformation;
wherein the predetermined oil-resistant material is selected from the group consisting of ethylene/acrylic elastomer, ethylene propylene diene rubber, tetrapropylene fluorine rubber, polyurethane rubber, acrylate rubber, fluoro rubber, butyl rubber, styrene-butadiene rubber, isoprene rubber and nitrile rubber, the fluorine rubber is fluorocarbon rubber, fluorosilicone rubber or fluoro-phosphazene rubber, and the nitrile rubber is hydrogenated nitrile rubber; and
wherein the predetermined oil-resistant material further includes a filler configured to adjust hardness, heat resistance and air tightness, a bridging agent configured to initiate polymerization, an anti-aging agent configured for antioxidant and anti-aging, and a processing aid configured for improving rubber flow, the filler includes carbon black or non-carbon black, the bridging agent includes sulfur or peroxide, and the processing aid includes processing oil or plasticizer.

7. The wound capacitor packaging structure according to claim 5,
wherein the oleophobic and high-temperature-resistant structure of the sealing element is configured to reduce the corrosiveness of the elastomeric seal structure by an oil-containing cooling liquid;
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, an outer surrounding surface connected between the upper surface and the lower surface, and at least two through holes connected between the upper surface and the lower surface, and the oleophobic and high-temperature-resistant structure includes an oleophobic and high-temperature-resistant structural layer containing a predetermined oil-resistant material;
wherein, when the upper surface, the lower surface and the outer surrounding surface of the elastomeric seal structure are covered by the oleophobic and high-temperature-resistant structural layer, the elastomeric seal structure is completely covered by the oleophobic and high-temperature-resistant structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic and high-temperature-resistant structural layer, the elastomeric seal structure is partially covered by the oleophobic and high-temperature-resistant structural layer, thereby preventing both the upper surface and the outer surrounding surface of the elastomeric seal structure from contacting the oil-containing cooling liquid;
wherein, when the upper surface of the elastomeric seal structure is covered by the oleophobic and high-temperature-resistant structural layer, the elastomeric seal structure is partially covered by the oleophobic and high-temperature-resistant structural layer, thereby preventing the upper surface of the elastomeric seal structure from contacting the oil-containing cooling liquid;
wherein, when an inner surface of each of the plurality of through holes of the elastomeric seal structure is covered by the oleophobic and high-temperature-resistant structural layer, the elastomeric seal structure is partially covered by the oleophobic and high-temperature-resistant structural layer, thereby preventing the inner surface of each of the plurality of through holes of the elastomeric seal structure from contacting the oil-containing cooling liquid;
wherein, before the sealing element is pressed by the surrounding concave position-limiting portion, the elastomeric seal structure of the sealing element has an outer surrounding plane portion, and the outer surrounding plane portion of the elastomeric seal structure has an outer surrounding plane configured to correspond to the surrounding concave position-limiting portion;
wherein the predetermined oil-resistant material is selected from the group consisting of ethylene/acrylic elastomer, ethylene propylene diene rubber, tetrapropylene fluorine rubber, polyurethane rubber, acrylate rubber, fluoro rubber, butyl rubber, styrene-butadiene rubber, isoprene rubber and nitrile rubber, the fluorine rubber is fluorocarbon rubber, fluorosilicone rubber or fluoro-phosphazene rubber, and the nitrile rubber is hydrogenated nitrile rubber; and
wherein the predetermined oil-resistant material further includes a filler configured to adjust hardness, heat resistance and air tightness, a bridging agent configured to initiate polymerization, an anti-aging agent configured for antioxidant and anti-aging, and a processing aid configured for improving rubber flow, the filler includes carbon black or non-carbon black, the bridging agent includes sulfur or peroxide, and the processing aid includes processing oil or plasticizer.

8. The wound capacitor packaging structure according to claim 5,
wherein the oleophobic and high-temperature-resistant structure of the sealing element is configured to reduce the corrosiveness of the elastomeric seal structure by an oil-containing cooling liquid;
wherein the package casing has an opening, and the sealing element is configured to be disposed at the opening of the package casing so as to close the opening of the package casing;
wherein the oleophobic and high-temperature-resistant structure includes a plurality of oleophobic fillers each containing a predetermined oil-resistant material, and the oleophobic fillers are mixed into the elastomeric seal structure so as to form the sealing element having an oleophobic function;
wherein the predetermined oil-resistant material is selected from the group consisting of ethylene/acrylic elastomer, ethylene propylene diene rubber, tetrapropylene fluorine rubber, polyurethane rubber, acrylate rubber, fluoro rubber, butyl rubber, styrene-butadiene rubber, isoprene rubber and nitrile rubber, the fluorine rubber is fluorocarbon rubber, fluorosilicone rubber or fluoro-phosphazene rubber, and the nitrile rubber is hydrogenated nitrile rubber; and
wherein the predetermined oil-resistant material further includes a filler configured to adjust hardness, heat resistance and air tightness, a bridging agent configured to initiate polymerization, an anti-aging agent configured for antioxidant and anti-aging, and a processing aid configured for improving rubber flow, the filler includes carbon black or non-carbon black, the bridging agent includes sulfur or peroxide, and the processing aid includes processing oil or plasticizer.

9. A sealing element applied to a wound capacitor packaging structure including a wound assembly, a conductive assembly and a package casing;
wherein the sealing element is disposed inside the package casing and cooperating with the package casing, and the sealing element is configured to prevent the wound assembly from contacting an external environment;
wherein the package casing has a surrounding concave position-limiting portion recessed inward to press the sealing element, and a surrounding convex end portion protruding from the surrounding concave position-limiting portion to abut against the sealing element;
wherein the sealing element includes an elastomeric seal structure pressed by the surrounding concave position-limiting portion, and an oleophobic and high-temperature-resistant structure for protecting the elastomeric seal structure; and
wherein the wound capacitor packaging structure is configured to provide a predetermined initial capacitance, the oleophobic and high-temperature-resistant structure of the sealing element is configured to enable the wound capacitor packaging structure to retain more than 93% of the predetermined initial capacitance when the wound capacitor packaging structure is powered off at a maximum temperature of 150° C. for less than 4,000 hours, and the oleophobic and high-temperature-resistant structure of the sealing element is configured to enable the wound capacitor packaging structure to retain more than 85% of the predetermined initial capacitance when the wound capacitor packaging structure is powered on at a maximum temperature of 150° C. for less than 4,000 hours.

10. The sealing element according to claim 9,
wherein the oleophobic and high-temperature-resistant structure of the sealing element is configured to reduce the corrosiveness of the elastomeric seal structure by an oil-containing cooling liquid;
wherein the package casing has an opening, and the sealing element is configured to be disposed at the opening of the package casing so as to close the opening of the package casing;
wherein the elastomeric seal structure has an upper surface facing away from the wound assembly, a lower surface facing the wound assembly, an outer surrounding surface connected between the upper surface and the lower surface, and at least two through holes connected between the upper surface and the lower surface, and the oleophobic and high-temperature-resistant structure includes an oleophobic and high-temperature-resistant structural layer containing a predetermined oil-resistant material;
wherein, when the upper surface, the lower surface and the outer surrounding surface of the elastomeric seal structure are covered by the oleophobic and high-temperature-resistant structural layer, the elastomeric seal structure is completely covered by the oleophobic and high-temperature-resistant structural layer, thereby preventing the upper surface, the lower surface and the outer surrounding surface of the elastomeric seal structure from contacting the oil-containing cooling liquid;
wherein, when the upper surface and the outer surrounding surface of the elastomeric seal structure are covered by the oleophobic and high-temperature-resistant structural layer, the elastomeric seal structure is partially covered by the oleophobic and high-temperature-resistant structural layer, thereby preventing both the upper surface and the outer surrounding surface of the elastomeric seal structure from contacting the oil-containing cooling liquid;
wherein, when the upper surface of the elastomeric seal structure is covered by the oleophobic and high-temperature-resistant structural layer, the elastomeric seal structure is partially covered by the oleophobic and high-temperature-resistant structural layer, thereby preventing the upper surface of the elastomeric seal structure from contacting the oil-containing cooling liquid;
wherein, when an inner surface of each of the plurality of through holes of the elastomeric seal structure is covered by the oleophobic and high-temperature-resistant structural layer, the elastomeric seal structure is partially covered by the oleophobic and high-temperature-resistant structural layer, thereby preventing the inner surface of each of the plurality of through holes of the elastomeric seal structure from contacting the oil-containing cooling liquid;
wherein, before the sealing element is pressed by the surrounding concave position-limiting portion, the elastomeric seal structure of the sealing element has an outer surrounding concave portion, the outer surrounding concave portion of the elastomeric seal structure has an outer surrounding concave space configured to accommodate a part of the surrounding concave position-limiting portion, and a concave contour of the outer surrounding concave portion of the elastomeric seal structure and a concave contour of the surrounding concave position-limiting portion of the package casing correspond to each other;
wherein, after the sealing element is pressed by the surrounding concave position-limiting portion, a large part of the outer surrounding concave portion of the elastomeric seal structure is uniformly pressed by the surrounding concave position-limiting portion, so that an outer peripheral area of the outer surrounding concave portion of the elastomeric seal structure has an approximate amount of deformation;
wherein the predetermined oil-resistant material is selected from the group consisting of ethylene/acrylic elastomer, ethylene propylene diene rubber, tetrapropylene fluorine rubber, polyurethane rubber, acrylate rubber, fluoro rubber, butyl rubber, styrene-butadiene rubber, isoprene rubber and nitrile rubber, the fluorine rubber is fluorocarbon rubber, fluorosilicone rubber or fluoro-phosphazene rubber, and the nitrile rubber is hydrogenated nitrile rubber; and
wherein the predetermined oil-resistant material further includes a filler configured to adjust hardness, heat resistance and air tightness, a bridging agent configured to initiate polymerization, an anti-aging agent configured for antioxidant and anti-aging, and a processing aid configured for improving rubber flow, the filler includes carbon black or non-carbon black, the bridging agent includes sulfur or peroxide, and the processing aid includes processing oil or plasticizer.
